(19) United States
(12) Patent Application Publication
(10) Pub. No.: US 2024/0176340 A1
(43) Pub. Date: May 30, 2024

(54) Causal Analysis of an Anomaly Based on Simulated Symptoms

(71) Applicant: Siemens Aktiengesellschaft, Muenchen (DE)

(72) Inventor: Daniel LABISCH, Karlsruhe (DE)

(21) Appl. No.: 18/283,334

(22) PCT Filed: Mar. 21, 2022
(86) PCT No.: PCT/EP2022/057334

§ 371 Date: Sep. 21, 2023

(30) Foreign Application Priority Data
Mar. 22, 2021 (EP) 21163887

(51) Int. Cl. G05B 23/02

(52) U.S. Cl. CPC G05B 23/024

(57) ABSTRACT

A method for determining anomaly causes during operation of a technical plant includes simulating error-free operation of the technical plant, simulating individual causes of an anomaly occurring during operation of the technical plant, comparing simulated error-free operating states for each cause of the anomaly with the simulated operating states when the cause of an anomaly occurs, deriving from the comparison a qualitative symptom that describes a qualitative deviation of the operating state from the error-free operating state; determining a qualitative symptom of the anomaly if the anomaly occurs during operation of the technical plant, comparing the symptom with each symptom previously derived during simulations of the operating states when a cause of an anomaly is present, identifying symptoms having a determined degree of similarity to the symptom; and storing causes of the anomaly associated with the identified symptoms in a data memory of the technical plant and/or displaying them.

### CROSS-REFERENCE TO RELATED APPLICATIONS

This is a U.S. national stage of application No. PCT/EP2022/057334 filed 21 Mar. 2022. Priority is claimed on European Application No. 21163887.9 filed 22 Mar. 2021, the content of which is incorporated herein by reference in its entirety.

### BACKGROUND OF THE INVENTION

### 1. Field of the Invention

The invention relates to a method for determining a cause of an anomaly during operation of a technical plant, a computer program with program code instructions executable by a computer, a storage medium with a computer-executable computer program, a server, in particular an operator station server, for the technical plant and a control system for the technical plant.

### 2. Description of the Related Art

A technical plant, in particular a production or process plant, is usually monitored continuously to avoid unfavorable operating conditions. The detection of a deviation in the operation of the technical plant (anomaly detection) already provides added value, even if the search for the cause of the anomaly must be performed completely manually. The added value can be increased if information is also available about which components of the technical plant deviate from their normal behavior and in what way (detection of symptoms).

A manual search for the cause is laborious and time-consuming. Various attempts have therefore been known at allowing determination of the causes of the deviations automatically, so that the plant personnel can start eliminating the cause immediately. In general, a distinction can be made between two approaches.

A first approach involves a purely data-based search for the cause. An identification of the cause is only possible in this way if the cause has already occurred in the past and has been classified accordingly.

A second approach is based on models. A model of the technical plant or its components is created based on the plant structure of the technical plant (e.g., the pipeline and instrument flow diagram). This is then used to allocate recognized symptoms to possible causes.

A wide variety of methods can be used for modeling. In EP 2568348 A1, EP 2587328 A1 and EP 2587329 A1 such modeling based on “signed digraphs” is described. With this, optimal results can be achieved when determining the causes for small plant topologies (the size of a research plant). However, the methods described here are less suitable for larger, real technical plants. In particular, branches in the plant topology can lead to empty cause sets or to an excessive number of possible causes.

In a review, [1] and [2] provide a systematic overview of possible algorithms for root cause analysis.
[1] Venkat Venkatasubramanian, Raghunathan Rengaswamy, Kewen Yin, Surya N. Kavuri; A review of process fault detection and diagnosis Part I: Quantitative model-based methods; Computers and Chemical Engineering, issue 27, pp. 293-31t,2003.
[2] Venkat Venkatasubramanian, Raghunathan Rengaswamy, Surya N. Kavuri; A review of process fault detection and diagnosis Part II: Qualitative Models and Search Strategies; Computers and Chemical Engineering, issue 27, pp. 313-326, 2003.

However, a relatively high level of complexity and a high level of modeling effort are intrinsic to the methods mentioned therein.

Where it is intended to use an existing process model as an aid for anomaly detection, the following three approaches can be found in [3] and [4]:
Parameter estimation or parameter identification method
Observer-based methods
Parity equations

These anomaly detection methods are expanded to include several different error models for error diagnosis. If, instead of the real model, one of the error models matches the process data, then an error can be diagnosed. The error models consider a known problem in exactly one version/error level and then make a statement about a binary error (e.g., valve works or valve does not work). If, on the other hand, several similar error models show a positive diagnostic result, no clear statement or recommendation can be made.

Errors of varying severity (e.g., material contamination, process inhibitions, etc.) cannot be represented with a model with constant parameters, but can only be described with a large number of different error models. This results in an increased effort for the modeling of the error models. An unmanageable number of models also results.

Alternatively, observer-based approaches are used that also estimate an error parameter. The disadvantage of these is that observers only converge when the model quality is high and only provide bias-free estimates if, for example, all noise assumptions are correctly met.

What all solutions have in common is that the model quality must be very good for both normal and abnormal behavior. This requirement is not always met even for models in normal operation. However, due to a lack of error data, such precise modeling for error cases generally fails.
[3]: R. Isermann, “Modellbasierte Überwachung und Fehlerdiagnose von kontinuierlichen technischen Prozessen,” [Model-based monitoring and fault diagnosis of continual technical processes] at, June 2010
[4]: S. X. Ding, “Model-Based Fault Diagnosis Techniques”, Duisburg, 2013

### SUMMARY OF THE INVENTION

It is an object of the invention to provide a method for determining a cause of an anomaly during operation of a technical plant, where the method can be performed efficiently, with little effort and in an automated manner.

This and other object is achieved by a method for determining a cause of an anomaly during operation of a technical plant, in particular a production or process plant, by a computer program with program code instructions that are executable by a computer, by a storage medium with a computer-executable computer program, a server including a processor and memory, in particular an operator station server, for the technical plant, in particular a production or process plant and by a control system for the technical plant, where the method in accordance with the invention comprises:
a) Simulating an error-free operation of the technical plant via a computer-implemented simulation tool;
b) Simulating a plurality of individual causes of an anomaly occurring during operation of the technical plant;
c) For each of the plurality of individually occurring causes of an anomaly, comparing the simulated error-free operating state with the simulated operating state when one of the occurring causes of an anomaly is present, where a qualitative symptom is derived from each of the comparisons that describes a qualitative deviation of the operating state from the error-free operating state;
d) Real operation of the technical plant;
e) If an anomaly occurs during real operation of the technical plant, determining a qualitative symptom of the anomaly;
f) Comparing the symptom determined during real operation of the technical plant with each symptom previously derived in the simulations of the operating states when one of the occurring causes of an anomaly is present;
g) Identifying those symptoms that have a determined degree of similarity to the symptom determined during real operation of the technical plant, and storing the causes of the anomaly associated with the identified symptoms in a data memory of the technical plant and/or displaying the causes of the anomaly associated with the identified symptoms.

The technical plant can be a plant from the process industries, e.g. chemical, pharmaceutical, petrochemical, or a plant from the food and beverages industries. This also includes any plants from the production industries, such as plants in which, for example, cars or goods of all kinds are produced. Technical plants that are suitable for performing the method in accordance with the invention can also be found in the field of energy production. Wind turbines, solar plants or power stations for generating energy are also covered by the term technical plant.

These systems usually have a control system or at least a computer-aided module for controlling and regulating the ongoing process or production. Part of the control system or control module or a technical plant is at least a database or an archive in which historical data is stored.

The method in accordance with the invention is based on the fact that real data and simulated model data are compared with one another via the intermediate step of including symptoms in order to be able to deduce the cause of an anomaly during the operation of the technical plant. The term “symptom” comes from the area of monitoring a technical plant and describes the deviations from normal operation of the technical plant. Specifically, a symptom includes the deviating variables and the type of the respective deviation. In accordance with the invention, this deviation is only considered qualitatively. Examples of possible symptoms are: The pressure value of sensor X is too large or too small, the temperature value of sensor Y is much too low or much too high. The quantization of the qualitative symptom can be limited to three levels (high/no deviation/low), but can also have more levels.

When implementing the method in accordance with the invention, it is assumed that there is a corresponding simulation model for the technical plant. It is assumed that the simulation model includes possible anomalies and their causes, where the intensity of the anomalies can be varied or the anomalies are configured as binary (anomaly present/not present).

All simulations of possible individually occurring causes of anomalies are compared with the simulated normal operation and the difference is framed as a symptom. The simulation correctly reflects the basic behavior. Consequently, the symptom is also generally correct. In this context, reference is also made to the description of the exemplary embodiment and the associated description of trials.

The great advantage of the method in accordance with the invention lies in the fact that the requirements for the simulation model are reduced considerably because it does not have to be exact and calibrated for all cases. In contrast to many others, the method is therefore of general practical use.

In method step g, only those symptoms can be identified and stored in the data memory and/or displayed that are identical to the symptom determined during actual operation of the technical plant.

However, it is also possible that in method steps b and c, for each possible cause of an anomaly, an intensity of the cause of the anomaly is varied within a specific range, where upon variation it is possible to derive a plurality of symptoms, which, if applicable, are used to identify the cause of the anomaly in step g. The background to this is that, particularly in the case of non-linearities in the technical plant, a variation in the intensity of an anomaly can lead to different symptoms (depending on the degree of intensity). The appropriately developed procedure can significantly improve the detection of the cause of an anomaly.

The objects and advantages are also achieved in accordance with the invention by a computer program with program code instructions executable by a computer for implementing the disclosed method in accordance with the invention. In addition, the objects and advantage are achieved by a storage medium with a computer program as explained above that can be executed by a computer, and a computer system on which a computer program as explained above is implemented.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The characteristics, features and advantages of this invention described above and the way in which these are achieved, will become clearer and easier to understand from the following description of the exemplary embodiment, which is explained in more detail in conjunction with the drawings, in which:

FIG. 1 is a diagram of a technical plant with three tanks;

FIG. 2 shows graphical plots of a comparison of real and simulated measurement data;

FIG. 3 shows graphical plots of a symptom formation in the case of a first anomaly;

FIG. 4 shows graphical plots of a symptom formation in the case of a second anomaly;

FIG. 5 shows graphical plots of a symptom formation in the case of a third anomaly;

FIG. 6 is a flowchart of the method in accordance with the invention.

### DETAILED DESCRIPTION OF THE EXEMPLARY EMBODIMENTS

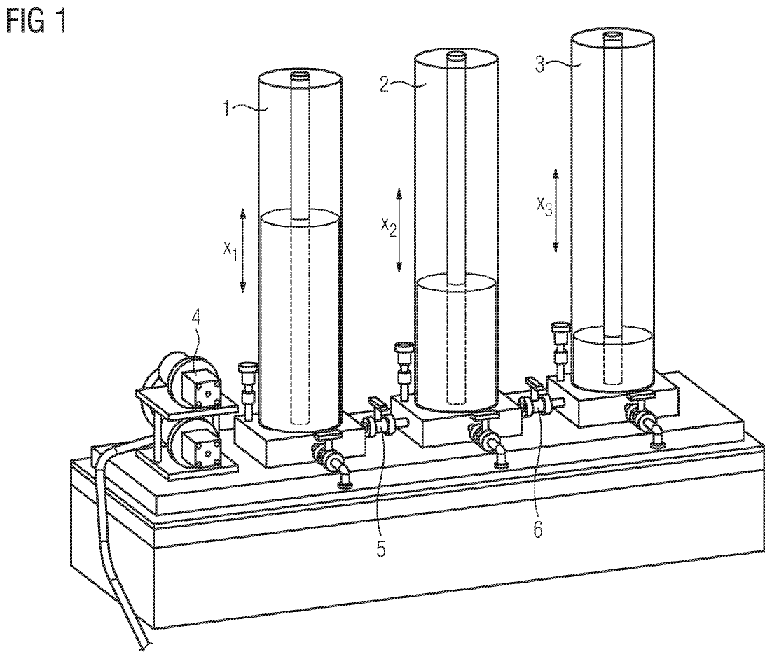

FIG. 1 shows a real three-tank test rig as a technical plant. The three-tank test rig has a first tank 1, a second tank 2, and a third tank 3. A pump 4 is connected to the first tank 1 and to the third tank 3 in FIG. 1 in order, for example, to be able to pump water into the respective tank 1, 3.

The first tank 1 is connected to the second tank 2 via a first connecting line 5. The second tank 2 is connected to the third tank 3 via a second connecting line 6. Water can escape from the third tank via a drain. The fill levels of the water in the three tanks 1, 2, 3 decrease from the first tank 1 to the right toward the third tank 3 in FIG. 1.

The non-linear exact modeling of the fill levels in the three tanks 1, 2, 3 results in the following relationships:

$${\dot{x}}_{1} = \{ \begin{matrix}\frac{1}{{A}_{1}} ( {u}_{1} - {q}_{1} \sqrt{2 g ( {x}_{1} - {x}_{2} )} ) if {x}_{1} \geq {x}_{2} \\ \frac{1}{{A}_{1}} ( {u}_{1} + {q}_{1} \sqrt{2 g ( {x}_{2} - {x}_{1} )} ) if {x}_{1} < {x}_{2}\end{matrix} ) \qquad Eq . 1$$

$${\dot{x}}_{2} = \{ \begin{matrix}\frac{1}{{A}_{2}} ( - {q}_{1} \sqrt{2 g ( {x}_{2} - {x}_{1} )} - {q}_{2} \sqrt{2 g ( {x}_{2} - {x}_{3} )} ) if {x}_{2} \geq {x}_{1} ∧ {x}_{2} \geq {x}_{3} \\ \frac{1}{{A}_{2}} ( - {q}_{1} \sqrt{2 g ( {x}_{2} - {x}_{1} )} + {q}_{2} \sqrt{2 g ( {x}_{3} - {x}_{2} )} ) if {x}_{2} \geq {x}_{1} ∧ {x}_{2} < {x}_{3} \\ \frac{1}{{A}_{2}} ( {q}_{1} \sqrt{2 g ( {x}_{1} - {x}_{2} )} - {q}_{2} \sqrt{2 g ( {x}_{2} - {x}_{3} )} ) if {x}_{2} < {x}_{1} ∧ {x}_{2} \geq {x}_{3} \\ \frac{1}{{A}_{2}} ( {q}_{1} \sqrt{2 g ( {x}_{1} - {x}_{2} )} + {q}_{2} \sqrt{2 g ( {x}_{3} - {x}_{2} )} ) if {x}_{2} < {x}_{1} ∧ {x}_{2} < {x}_{3}\end{matrix} ) \qquad Eq . 2$$

$${\dot{x}}_{3} = \{ \begin{matrix}\frac{1}{{A}_{3}} ( {u}_{2} - {q}_{2} \sqrt{2 g ( {x}_{3} - {x}_{2} )} - {q}_{3} \sqrt{2 {gx}_{3}} ) if {x}_{3} \geq {x}_{2} \\ \frac{1}{{A}_{3}} ( {u}_{2} + {q}_{2} \sqrt{2 g ( {x}_{2} - {x}_{3} )} - {q}_{3} \sqrt{2 {gx}_{3}} ) if {x}_{3} < {x}_{2}\end{matrix} ) \qquad Eq . 3$$

Where:
x₁ denotes the fill level of the water in the first tank 1;
x₂ denotes the fill level of the water in the second tank 2;
x₃ denotes the fill level of the water in the third tank 3;
A₁ denotes the cross-sectional area of the first tank 1;
A₂ denotes the cross-sectional area of the second tank 2;
A₃ denotes the cross-sectional area of the third tank 3;
q₁ demotes the cross-sectional area of the first connecting line 5 between the first tank 1 and the second tank 2;
q₂ demotes the cross-sectional area of the second connecting line 6 between the second tank 2 and the third tank 3;
q₃ denotes the cross-sectional area in the outlet of tank 3;
g denotes the acceleration due to gravity;
u₁ denotes the inflow into the first tank 1; and
u₂ denotes the inflow into the third tank 3.

The operation of this simple technical plant can be simulated by linearization of the system. For this the following simulation model can be used:

\dot{x}*=Ax*+Bu*,x*(0)=x₀* Eq. 4

Where the following applies to [A|B]:

$$( \begin{matrix}\frac{- {q}_{1}}{{A}_{1}} \sqrt{\frac{g}{2 ( {x}_{1} - {x}_{2} )}} & \frac{{q}_{1}}{{A}_{1}} \sqrt{\frac{g}{2 ( {x}_{1} - {x}_{2} )}} & 0 \\ \frac{{q}_{1}}{{A}_{2}} \sqrt{\frac{g}{2 ( {x}_{1} - {x}_{2} )}} & \frac{- 1}{{A}_{2}} ( {q}_{1} \sqrt{\frac{g}{2 ( {x}_{1} - {x}_{2} )}} + {q}_{2} \sqrt{\frac{g}{2 ( {x}_{2} - {x}_{3} )}} ) & \frac{{q}_{2}}{{A}_{2}} \sqrt{\frac{g}{2 ( {x}_{2} - {x}_{3} )}} \\ 0 & \frac{{q}_{2}}{{A}_{3}} \sqrt{\frac{g}{2 ( {x}_{2} - {x}_{3} )}} & \frac{- 1}{{A}_{3}} ( {q}_{2} \sqrt{\frac{g}{2 ( {x}_{2} - {x}_{3} )}} + {q}_{3} \sqrt{\frac{g}{2 {x}_{3}}} )\end{matrix} \vert \begin{matrix}\frac{1}{{A}_{1}} & 0 \\ 0 & 0 \\ 0 & \frac{1}{{A}_{3}}\end{matrix} ) \qquad Eq . 5$$

The linear simulation model only applies to descending fill levels and is assumed to be uncalibrated. This lack of calibration is achieved by varying the parameters of the simulation model by 20%.

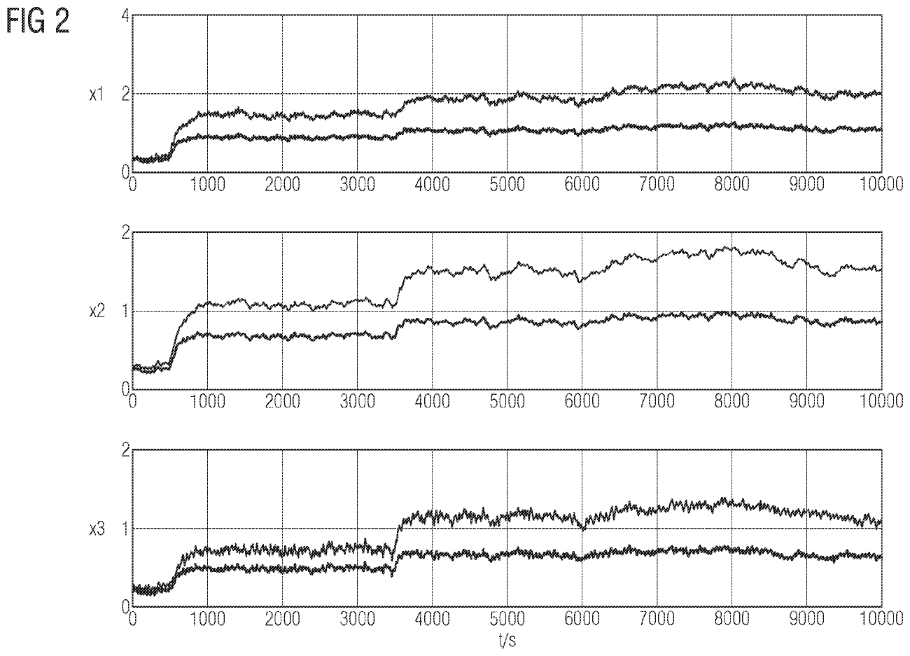

FIG. 2 shows a comparison of the real data for the fill levels x₁, x₂ and x₃ in the three tanks 1, 2, 3 (non-linear simulation) with simulated data that is generated with the previously explained linear simulation model for an inflow jump in the inflows of the first tank 1 and the third tank 3. The deviations between the simulation data and the real data caused by the parameter variation and the linearization are clearly visible. FIG. 2 shows the real data in the chronological progression diagrams each arranged above the simulated values (i.e., greater). It is also clear from this that the fundamental behavior of the technical plant is reproduced by the simulation.

Three possible causes of an anomaly in the operation of the three-tank test rig are considered below:
Cause 1: A partial blockage of the connecting line 5 between the first tank 1 and the second tank 2 (reduction of the cross-sectional area q₁).
Cause 2: A partial blockage of the connecting line 6 between the second tank 2 and the third tank 3 (reduction of the cross-sectional area q₂).
Cause 3: A leak from the third tank 3 (reduction of the inflow u₂ into the third tank 3).

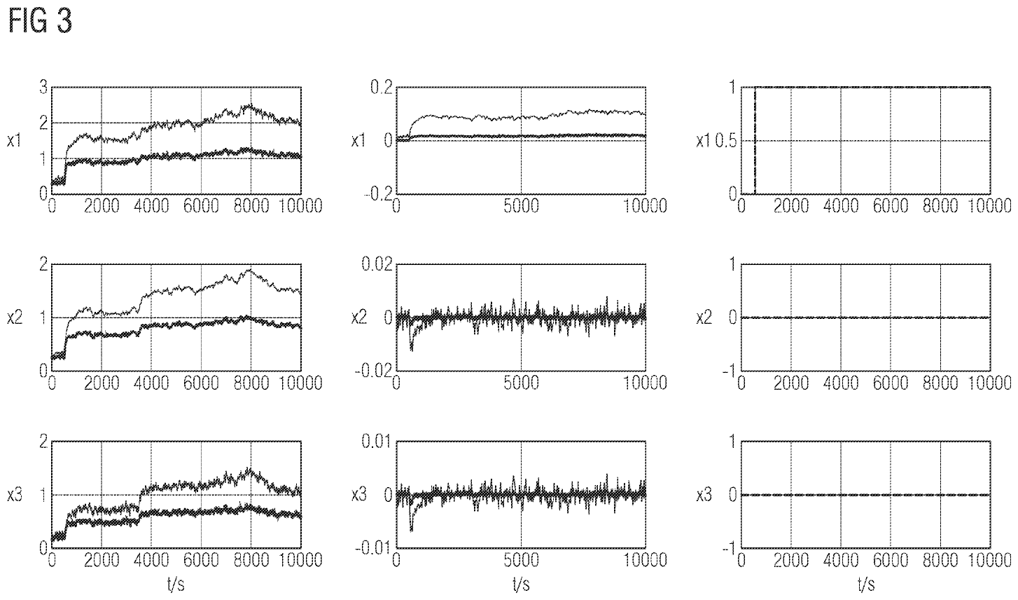

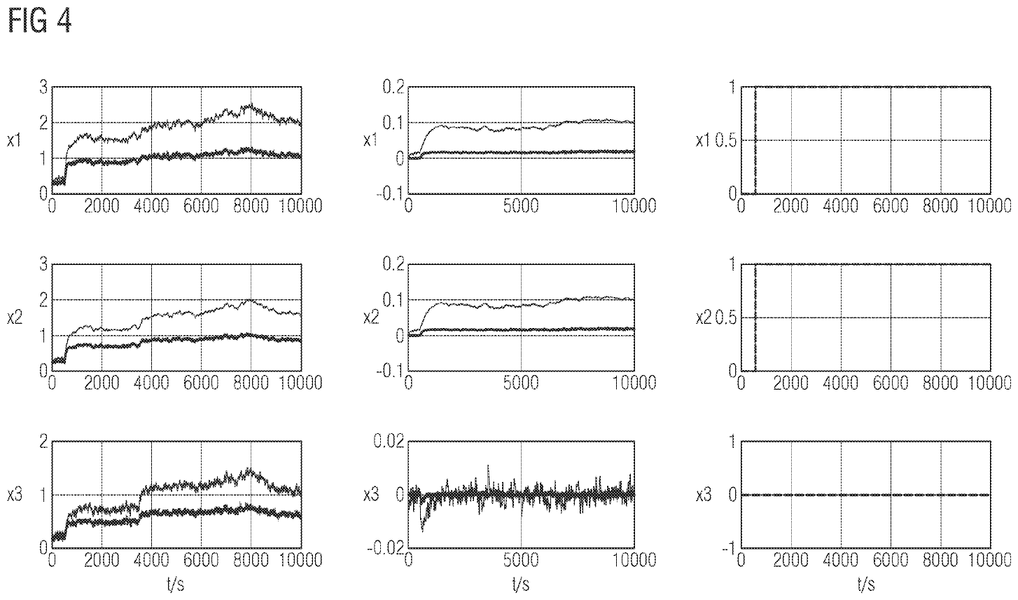

In FIGS. 3 to 5, the three causes 1-3 of anomalies are dealt with one after another, where in the respective left column the real measurement data (e.g., the fill levels x₁, x₂, x₃) are compared with the simulated data. This shows that it is difficult to allocate the anomalies, because the model errors (20%) explained above lead to greater discrepancies between the simulated and real data than the discrepancies due to the anomalies.

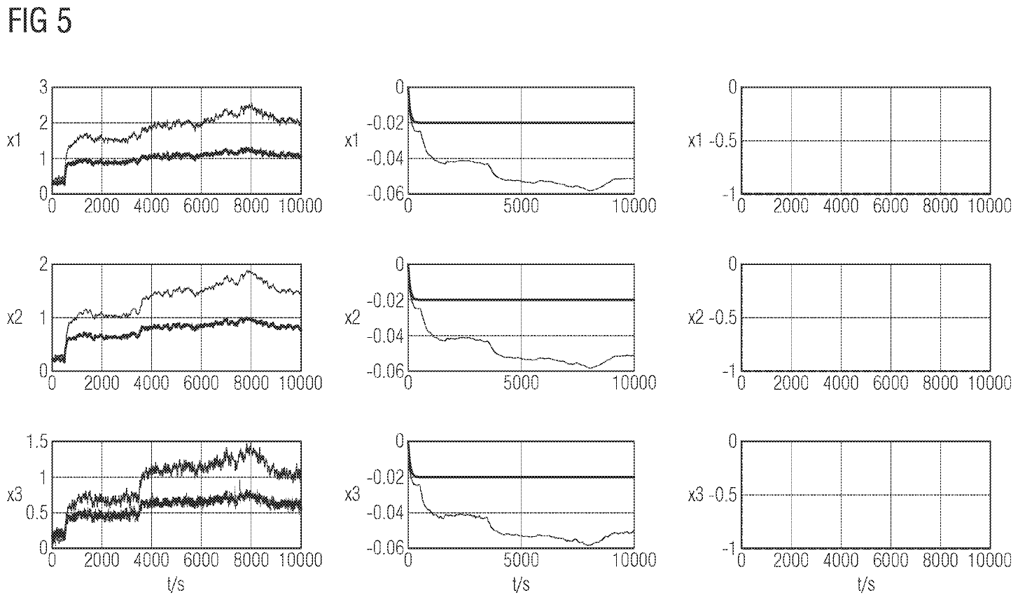

In the middle column, the symptoms are shown as exact values that are not yet ideally suited for diagnostic analysis. The symptoms are shown in the right-hand column, where the symptoms are quantized to three levels (0=the same, 1=too large, −1=too small). In FIG. 3, for example, the quantized symptom for the fill level x has a value “too large” (designated here with 1). In FIG. 5, for example, all three symptoms have a value “too small” (designated with −1). It is clear that the quantized (qualitative) symptoms of the real and the simulated measurement data match.

The symptoms determined during real operation of the three-tank test rig are then compared with each symptom that was previously derived in simulations of the operating states when one of the occurring causes of an anomaly is present. Thereupon, those symptoms having a specific degree of similarity to the symptom determined during real operation of the three-tank test rig are identified and the causes of the anomaly associated with the identified symptoms are stored in a data memory and/or via a display unit presented visually to an operator of the three-tank test rig. Due to the previously mentioned correspondence of the symptoms of real and simulated measurement data, the allocation of the symptoms to the causes of the respective anomaly is unequivocal.

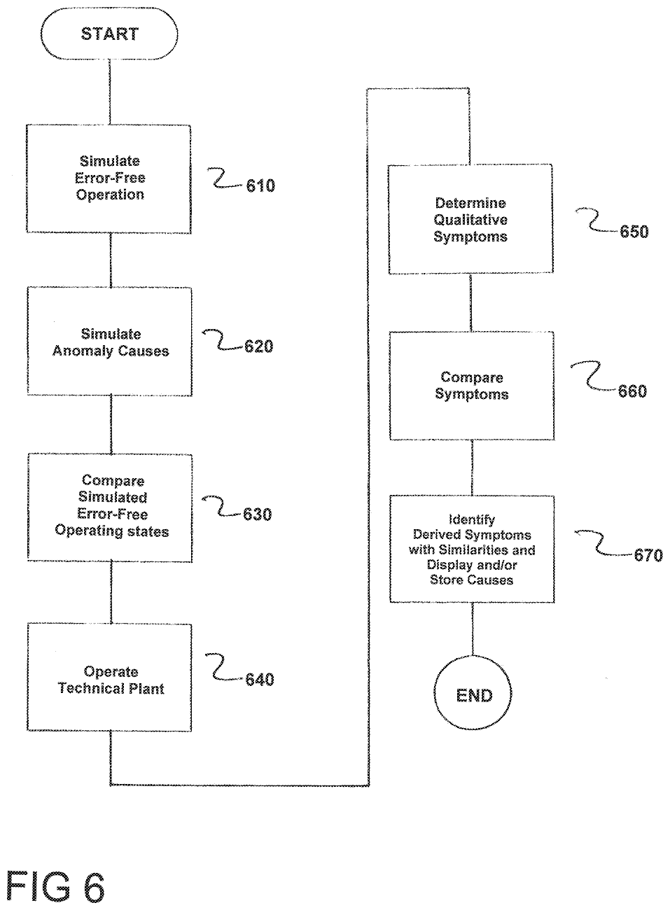

FIG. 6 is a flowchart of the method for determining a cause of an anomaly during operation of a technical plant.

The method comprises a) simulating an error-free operation of the technical plant via a computer-implemented simulation tool, as indicated in step 610.

Next, b) simulating a plurality of individual causes of an anomaly occurring are simulated during operation of the technical plant, as indicated in step 620.

Next, c) the simulated error-free operating state for each of the plurality of individually occurring causes of an anomaly is compared with the simulated operating state when one of the occurring causes of an anomaly is present, as indicated in step 630. In accordance with the method, each qualitative symptom is derived from the comparison which describes a qualitative deviation of the simulated operating state from the error-free operating state;

Next, d) the technical plant is operated, as indicated in step 640.

Next, e) determining a qualitative symptom of the anomaly is determined if an anomaly occurs during real operation of the technical plant, as indicated in step 650.

Next, f) comparing the symptom determined during real operation of the technical plant is compared with each symptom previously derived during simulations of the operating states when one of the occurring causes of an anomaly is present, as indicated in step 660.

Next, g) those derived symptoms having a determined degree of similarity to the symptom determined during real operation of the technical plant are identified, and at least one of storing causes of the anomaly associated with the identified symptoms are either stored in a data memory of the technical plant or the causes of the anomaly associated with the identified symptoms are displayed, as indicated in step 670.

Although the invention has been illustrated and described in more detail by the preferred exemplary embodiment, this shall not limit the invention to the disclosed example and other variations may be deduced from these by the person skilled in the art without extending beyond the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method for determining a cause of an anomaly during operation of a technical plant, the method comprising:
a) simulating an error-free operation of the technical plant via a computer-implemented simulation tool;
b) simulating a plurality of individual causes of an anomaly occurring during operation of the technical plant;
c) comparing the simulated error-free operating state for each of the plurality of individually occurring causes of an anomaly with the simulated operating state when one of the occurring causes of an anomaly is present, each qualitative symptom being derived from the comparison which describes a qualitative deviation of the simulated operating state from the error-free operating state;
d) operating the technical plant;
e) determining a qualitative symptom of the anomaly if an anomaly occurs during real operation of the technical plant;
f) comparing the symptom determined during real operation of the technical plant with each symptom previously derived during simulations of the operating states when one of the occurring causes of an anomaly is present; and
g) identifying those derived symptoms having a determined degree of similarity to the symptom determined during real operation of the technical plant, and at least one of storing causes of the anomaly associated with the identified symptoms in a data memory of the technical plant and displaying the causes of the anomaly associated with the identified symptoms.

9. The method as claimed in claim 8, wherein during said identifying those symptoms which are identical to the symptom determined during actual operation of the technical plant are identifiable and at least of stored in the memory and displayed.

10. The method as claimed in claim 8, wherein during said simulating a plurality of individual causes of an anomaly and said comparing the simulated error-free operating state, an intensity of the cause of the anomaly is varied within a specific range for each possible cause of an anomaly, and wherein upon variation a plurality of symptoms are derivable, which, if applicable, are utilized to identify the cause of the anomaly during said identifying.

11. The method as claimed in claim 9, wherein during said simulating a plurality of individual causes of an anomaly and said comparing the simulated error-free operating state, an intensity of the cause of the anomaly is varied within a specific range for each possible cause of an anomaly, and wherein upon variation a plurality of symptoms are derivable, which, if applicable, are utilized to identify the cause of the anomaly during said identifying.

12. The method as claimed in claim 8, wherein the technical plant comprises a production or process plant.

13. A computer program including program code instructions which, when executed by a computer, implement the method as claimed in claim 8.

14. A non-transitory computer-readable storage medium encoded with a computer executable computer program which, when executed by a computer, causes determination of a cause of an anomaly during operation of a technical plant, the computer program comprising:
a) program code for simulating an error-free operation of the technical plant via a computer-implemented simulation tool;
b) program code for simulating a plurality of individual causes of an anomaly occurring during operation of the technical plant;
c) program code for comparing the simulated error-free operating state for each of the plurality of individually occurring causes of an anomaly with the simulated operating state when one of the occurring causes of an anomaly is present, each qualitative symptom being derived from the comparison which describes a qualitative deviation of the simulated operating state from the error-free operating state;
d) program code for operating the technical plant;
e) program code for determining a qualitative symptom of the anomaly if an anomaly occurs during real operation of the technical plant;
f) program code for comparing the symptom determined during real operation of the technical plant with each symptom previously derived during simulations of the operating states when one of the occurring causes of an anomaly is present; and
g) program code for identifying those derived symptoms having a determined degree of similarity to the symptom determined during real operation of the technical plant, and at least one of storing causes of the anomaly associated with the identified symptoms in a data memory of the technical plant and displaying the causes of the anomaly associated with the identified symptoms.

15. A server for a technical plant, comprising:
a processor; and
memory;
wherein the processor is configured to:
a) simulate an error-free operation of the technical plant via a computer-implemented simulation tool;
b) simulate a plurality of individual causes of an anomaly occurring during operation of the technical plant;
c) compare the simulated error-free operating state for each of the plurality of individually occurring causes of an anomaly with the simulated operating state when one of the occurring causes of an anomaly is present, each qualitative symptom being derived from the comparison which describes a qualitative deviation of the simulated operating state from the error-free operating state;
d) determine a qualitative symptom of the anomaly if an anomaly occurs during real operation of the technical plant;
e) compare the symptom determined during real operation of the technical plant with each symptom previously derived during simulations of the operating states when one of the occurring causes of an anomaly is present; and
g) identify those derived symptoms having a determined degree of similarity to the symptom determined during real operation of the technical plant, and at least one of store causes of the anomaly associated with the identified symptoms in a data memory of the technical plant and display the causes of the anomaly associated with the identified symptoms.

16. The server as claimed in claim 15, wherein the server comprises an operator station server and the technical plant comprises a production or process plant.

17. A control system for a technical plant, comprising:
at least the server as claimed in claim 15; and
a client.

18. The control system as claimed in claim 17, wherein the server comprises an operator station server and the client comprises an operator station client.
